(19) United States
(12) Patent Application Publication
(10) Pub. No.: US 2009/0163178 A1
(43) Pub. Date: Jun. 25, 2009

(54) METHOD AND APPARATUS FOR DELETING COMMUNICATION INFORMATION IN A PORTABLE TERMINAL

(75) Inventor: Hee Song KIM, Gumi-si (KR)

Correspondence Address: THE FARRELL LAW FIRM, P.C., 290 Broadhollow Road, Suite 210E, Melville, NY, 11747, US

(73) Assignee: SAMSUNG ELECTRONICS CO., LTD., Suwon-si (KR)

(21) Appl. No.: 12/337,263

(22) Filed: Dec. 17, 2008

(30) Foreign Application Priority Data
Dec. 17, 2007 (KR) 2007-0132042

(51) Int. Cl. H04M 1/00; H04M 3/00; H04W 4/00

(52) U.S. Cl. 455/412.1; 455/418; 455/566

(57) ABSTRACT

A method and apparatus for deleting communication history wherein communication data is deleted while deleting a communication history in a portable terminal. When communication information about a particular phone number or a particular person name is intended to be deleted, the method can search and delete a communication history and communication data, where the communication history includes call history, missed call history, call rejection history, message history, etc.

### PRIORITY

This application claims priority to an application entitled “METHOD FOR DELETING COMMUNICATION INFORMATION IN PORTABLE TERMINAL” filed in the Korean Intellectual Property Office on Dec. 17, 2007 and assigned Serial No. 2007-0132042, the contents of which are incorporated herein by reference.

### BACKGROUND OF THE INVENTION

1. Field of the Invention

The present invention relates generally to portable terminals, and more particularly, to a communication history deletion method for deleting communication data when deleting a communication history in a portable terminal.

2. Description of the Related Art

In general, portable terminals display communication histories, such as incoming call history, outgoing call history, missed call history, message history, incoming rejected call history, etc., when a call key is pressed. Conveniently, a user can select a particular item from the communication history to make a call or to send a message. Similarly, the user can also save or delete a phone number selected from the communication history, or check information about the selected communication history, such as the date and time of the incoming and outgoing calls and the received and sent messages, call time, etc.

More specifically, when a user wants to delete message information from the portable terminal, the user must select the corresponding message history from the communication history and then message data saved in the message inbox, i.e., through an additional process, or the user must delete the corresponding message data in the message inbox and then the message history through an additional process. That is, the conventional communication information deleting method of a portable terminal requires the user delete the message data and delete the message history in two separate deleting process, in order to delete both types of message information.

### SUMMARY OF THE INVENTION

The present invention has been designed in view of the above and other problems, and provides a communication information deletion method for a portable terminal that can delete a communication history and communication data associated therewith, when the communication history is deleted.

The present invention also provides a communication information deletion method for a portable terminal that can search and delete a communication history, such as call history, message history, missed call history, call rejection history, etc., and communication data, such as message data, voice message data, image data in a video call, etc., when communication information about a particular phone number or a particular person is intended to be deleted.

In accordance with an aspect of the present invention, the present invention provides a communication information deleting method for a portable terminal. The method includes selecting a communication history to be deleted, searching for a communication data associated with the selected communication history, and deleting the communication history and the communication data.

In accordance with another aspect of the present invention, the present invention provides a communication information deleting method for a portable terminal. The method includes selecting a history for deleting an integral history from a communication history, searching for communication histories that include information identical to that of the history for deleting an integral history and communication data associated with the histories, and deleting the searched communication histories and the communication data.

In accordance with an aspect of the present invention, the present invention provides an apparatus for deleting communication information in a portable terminal. The apparatus comprises a memory for storing a communication history and communication information, a display unit for displaying the communication history and the communication information, and a controller for receiving a command to delete a selected history from the displayed communication history, searching for stored communication data associated with the selected communication history, and deleting the selected communication history and the stored associated communication data.

### BRIEF DESCRIPTION OF THE DRAWINGS

The above and other features, aspects, and advantages of the present invention will be more apparent from the following detailed description in conjunction with the accompanying drawings, in which:

FIG. 1 is a schematic block diagram illustrating a portable terminal according to an embodiment of the present invention;

FIG. 2 is a flow chart illustrating a process for deleting a communication history, according to an embodiment of the present invention;

FIG. 3 is a flow chart illustrating a process for deleting an integral history in a communication history, according to an embodiment of the present invention;

FIG. 4 illustrates screen shots of a portable terminal that display a process for deleting a communication history, according to an embodiment of the present invention; and

FIG. 5 illustrates screen shots of a portable terminal that display a process for deleting an integral history in a communication history, according to an embodiment of the present invention.

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or similar parts. Additionally, detailed descriptions of well-known functions and structures incorporated herein may be omitted to avoid obscuring the subject matter of the present invention.

The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, and that there may be various modifications, alterations, and equivalents thereof.

In the following description, although the portable terminal according to the present invention is described as a mobile communication terminal, it will be appreciated that the present invention is not limited to a mobile communication terminal. That is, the portable terminal according to the present invention stores and deletes communication information. Accordingly, the present invention can be applied to all information communication devices, multimedia devices, and their applications, for example, such as, mobile communication terminals, mobile phones, Personal Digital Assistants (PDAs), smart phones, International Mobile Telecommunication 2000 (IMT-2000) terminals, Code Division Multiple Access (CDMA) terminals, Wideband Code Division Multiple Access (WCDMA) terminals, Global System for Mobile communication (GSM) terminals, Universal Mobile Telecommunication Service (UMTS) terminals, digital broadcasting terminals, wired phones that can store and save communication information, etc.

Hereinafter, “information” includes history and data. For example, “communication information” includes a communication history and communication data, and “message information” includes a message history and message data.

The term “communication history” refers to log type information that includes a voice call history and a video call history (hereinafter referred to generically as a call history), message history, missed call history, call rejection history, etc. The term “communication history” may be accorded various names, such as, call history, recent call history, call list, etc., according to the purpose of the manufacturers or engineers of portable terminals. In the following description, the term “communication history” is displayed on a display unit by inputting a call key signal, by way of example, however, it should be understood that the present invention is not limited to inputting the call key signal in order to access the communication history. For example, the communication history may be displayed on the display unit by inputting a preset function key signal or by performing a selecting operation in a main menu of the portable terminal.

The term “communication data” is associated with the communication history and refers to voice message data of call contents, message data, image data in a video call, etc.

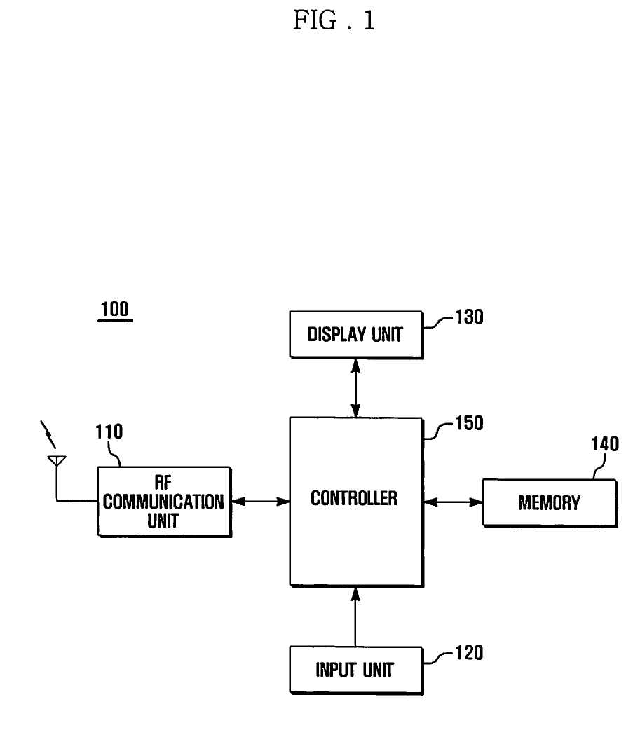

FIG. 1 is a schematic block diagram illustrating a portable terminal 100 according to an embodiment of the present invention.

Referring to FIG. 1, the portable terminal 100 includes a Radio Frequency (RF) communication unit 110, an input unit 120, a display unit 130, a memory 140, and a controller 150. The RF communication unit 110 transmits or receives a call request and message data to or from other portable terminals. The RF communication unit 110 includes an RF transmitter for up-converting the frequency of transmitted signals and amplifying the transmitted signals and an RF receiver for low-noise amplifying of received RF signals and down-converting the frequency of the received RF signals. In particular, the RF communication unit 110 can receive communication information including a phone number of a portable terminal that transmits a communication request thereto. It can also transmit communication information including its own phone number to the other portable terminal.

The input unit 120 preferably includes a plurality of input keys for inputting numerical or alphabetical information and a plurality of functions keys for setting a variety of functions. The functions keys include direction keys, side keys and shortcut keys, etc., that are set to perform specific functions. The input unit 120 generates key signals related to user settings and function controls of a portable terminal 100 and outputs them to the controller 150. In particular, the input unit 120 preferably includes a call key for displaying a communication history on the display unit 130, a menu key for generating a pop-up menu or a pop-up window, and a function key for checking message data.

The display unit 130 can display a variety of screen types according to operations of the portable terminal 100, e.g., a standby screen, a menu screen, and a call screen. For example, the display unit 130 may be implemented by a Liquid Crystal Display (LCD). In this case, the display unit 130 may further include an LCD controlling unit, a memory for storing data, and an LCD device. When the display unit 130 is implemented by an LCD, which has touch screen capabilities, the display unit 130 may also serve as the input unit 120.

The display unit 130 displays a communication history when a call key is input. The communication history includes call history, message history, missed call history, call rejection history, etc. When sent/received communication histories match a particular phone number saved in the phone book, the display unit 130 can display an index, matching with the particular, for example, a name or nickname that the user has previously input to his/her portable terminal, instead of displaying the particular phone number. When one of the communication histories is selected and a menu key is pressed, the display unit 130 can display a pop-up menu. The pop-up menu may include sub-menus giving options for various commands such as delete, delete all, delete integral history, reject call, save number, mark spam, and send a message.

When a deletion command is selected, the display unit 130 can display a pop-up window inquiring whether to delete a communication history, selected according to the control of the controller 150, and communication data associated with the communication history. When an integral history deletion command is selected in the pop-up menu, the display unit 130 can also display a pop-up window inquiring whether to delete a communication history and communication data associated therewith, where the communication history includes outgoing/incoming call history, sent/received message history, missed call history, call rejection history, etc., which are searched for by the controller 150.

The memory 140 stores an application program necessary for the operation of the portable terminal according to the present invention. It also stores user data, outgoing/incoming call history, sent/received message history, missed call history, call rejection history, and sent/received message data. In particular, the memory 140 can store communication history, communication data, and information associated with the communication history and communication data. This memory 140 is configured to include a program area and a data area.

The program area stores an Operating System (OS) for booting the portable terminal 100, a message service application program for processing messages, and application programs that are necessary for other optional functions of the portable terminal 100, such as an audio sound reproduction function, an image or moving image reproduction function, and a mobile broadcasting signal receiving function. In particular, the program area can store an application program that searches for outgoing/incoming call history, missed call history, call rejection history, sent/received message history, etc., which are commonly included in the communication history that is selected when an integral history is deleted in the communication history, and communication data associated with the searched communication history. The application program extracts a phone number from the selected communication history and searches for a communication history and data that have a phone number that is identical to the extracted phone number. However, it should be understood that the present invention is not limited by this embodiment. For example, the application program can search for a communication history having the identical name and communication data associated with the searched communication history. In addition, the application program can search for the representative number. For example, if there is a communication history of an advertisement, which has phone numbers, such as 060-124-****, 060-544-####, 060-5744-**##, etc., the application program can search for the communication history based on the common prefix, 060, and communication data associated with the searched communication history.

The data area stores data generated during use of the portable terminal 100. The data area stores user data related to a variety of optional functions provided with the portable terminal 100. An example of the user data is video images. The data area also stores phone information, audio data, and information corresponding to contents or user data. Preferably, the data area includes an area for storing a communication history, an area for storing communication data, and an area for storing information associating the communication history with the communication data. More specifically, the communication history storing area can store outgoing/incoming call history, sent/received message history, missed call history, and call rejection history. When the communication history is the outgoing/incoming call history, the communication history storing area can also store information about outgoing/incoming call time, call hour, etc.

The communication data storing area can store voice message data of call contents, message data, etc.

The associated-information storing area can store information that associates message history with message data. In addition, the associated-information storing area can store information that associates call history with voice message data. Furthermore, the associated-information storing area can store information that associates image data, stored when a video call is performed, with video call history.

The communication history and communication data can be stored in a database form, and associated with each other through the database.

The controller 150 controls the entire operation of the portable terminal 100 and controls signal flows between component blocks in the portable terminal 100. For example, the controller 150 controls the display unit 130 to display a communication history when a call key is input. When a history to be deleted from the communication history is selected and a deletion command is input, the controller 150 determines if the selected history is a message history. When the controller 150 has ascertained that the selected history is message history, it determines if there is message data. When a message data exists, the controller 150 may delete the message data while deleting the selected communication history. When an integral history deletion command of the selected history is input, the controller 150 can search for communication histories including phone numbers or names that are identical to those of a communication history to be deleted, where the communication histories refer to call rejection history, outgoing/incoming call history, missed call history, and sent/received message history. The controller 150 can also search for communication data associated with the communication histories. The searched communication histories and the communication data can be deleted together by the integral history deletion command.

As described above, the communication information deleting method can be set to be enabled or disabled in a setting menu of the portable terminal. When a message data is set to be protected, the controller 150 does not delete the message data or it displays a pop-up window indicating that the message data is protected and inquiring if the user still wishes to delete the message data.

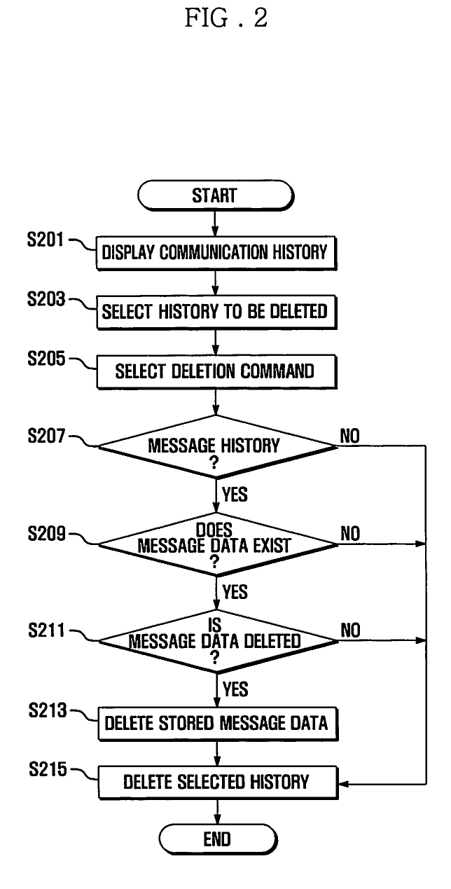

In the following description, a communication information deletion process is explained, with reference to FIG. 2, which selects a communication history to be deleted, searches for a selected communication data, and deletes the communication history and the communication data together.

FIG. 2 is a flow chart illustrating a process for deleting a communication history, according to an embodiment of the present invention. Referring to FIG. 2, the controller 150 displays communication histories, such as outgoing/incoming call history, sent/received message history, and missed call history, on the display unit 130 in step S201. Corresponding communication histories to be deleted are selected through the input unit 120 in step S203. If the display unit 130 is implemented by a touch screen, the communication history to be deleted can be selected by touching a corresponding region on the display unit 130. A deletion command for the selected communication history is input in step S205.

Thereafter, the controller 150 receives the deletion command and determines if the selected communication history is a message history in S207. When the controller 150 determines that the selected communication history is not a message history in step S207, it deletes the selected communication history in step S215.

However, when the controller 150 determines that the selected communication history is a message history in step S207, it determines if there is a message data associated with the message history in step S209.

When the controller 150 has ascertained that there is no message data associated with the message history at in step S209, it deletes the selected message history in step S215. However, when the controller 150 determines that there is message data associated with the message history in step S209, it determines if a stored message data will also be deleted in step S211.

When the controller 150 identifies not to delete the stored message data in step S211, it deletes only the selected message history in step S215. However, when the controller 150 identifies to delete the stored message data in step S211, it deletes the stored message data in step S213 and then deletes the message history in step S215.

Accordingly, the controller 150 can delete the message history and the message data together, i.e., it can delete communication information. Additionally, if the message data to be deleted is previously marked as protected, the controller 150 does not delete the message data or indicates that the message data is protected and inquires if the user still wishes to delete it.

In the embodiment described above, the communication information deleting method deletes communication histories and communication data when the communication history is a message history. However, it should be understood that the present invention is not limited by the above-described embodiment. For example, when there is a voice record data generated by recording call contents during the call, the communication information deleting method of the present invention can also be adapted to the call history. In addition, when a portable terminal is used that can perform a video call, the method can also be adapted to the video call history and the image data of a video call, which correspond to the stored video call contents.

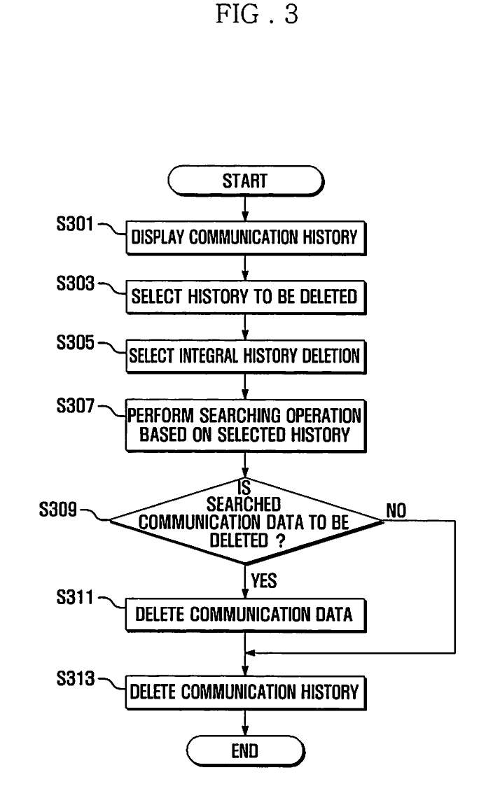

In the following description, an integral history deletion process is described, with reference to FIG. 3, which selects a communication history to be deleted, searches for communication histories and communication data that include information identical to that of the selected communication history, and deletes them integrally.

FIG. 3 is a flow chart illustrating a process for selecting one of the communication histories to be deleted, and deleting an integral history of the selected communication history, according to an embodiment of the present invention. Referring to FIG. 3, the controller 150 displays communication histories including outgoing/incoming call histories, sent/received message histories, missed call history, etc., on the display unit 130 in step S301. Corresponding communication histories to be deleted are selected through the input unit 120 in step S303. As described above, if the display unit 130 is implemented with a touch screen, the communication history to be deleted can be selected by touching a corresponding region of the touch screen.

An integral history deletion command is input to the controller 150 in step S305. The controller 150 searches for communication histories and communication data associated with the communication histories, which have information identical to that of the communication history selected in step S307, where the communication histories searched by the controller 150 include incoming call history, outgoing call history, missed call history, call rejection history, received message history, and sent message history. The identical information may be a phone number or name that is extracted from the communication history selected in step S303.

The controller 150 determines whether to delete the searched communication history and the communication data together in step S309.

When the controller 150 determines not to delete the searched communication data in step S309, only the searched communication history is deleted in step S313. However, when the controller 150 determines to delete the searched communication data in step S309, all the searched communication data is deleted in step S311, and all searched communication histories are deleted in step S313. Therefore, the controller 150 can complete the process for deleting an integral history where a communication history and communication data about a particular phone number or person name are deleted.

As described above, before communication data is deleted by the integral history deletion command, the controller 150 ascertains if communication data is as protected. If a communication data is set as protected, the controller 150 does not delete the communication data or indicates that the message data is protected and inquires if the user still wishes to delete it.

When the integral history is deleted, it is preferable that a phone number is extracted from the communication history selected to be deleted and then communication histories and communication data are searched that have a phone number identical to the extracted phone number.

It should be understood that the present invention is not limited to the searching method described above. For example, the searching method can be achieved based on name. If there are people with the same name, the controller 150 displays the same name on the display unit 130 and controls to determine whether to delete the integral history of all people with the same name or to delete an integral history of a selected person name. If a user selects to delete an integral history of a person, the controller 150 deletes an integral history of a person who is selected by a searching method based on a phone number. In addition, the searching method can be achieved based on a representative phone number. For example, if communication information of an advertisement, which has phone numbers, such as 060-124-****, 060-544-####, 060-5744-**##, etc., is intended to be deleted, the controller 150 searches for the common prefix, 060, in the phone numbers and then deletes all searched communication histories and communication data. If an integral history deletion is selected, this searching method may be achieved in such a way to display a selection menu on the display unit 130 so that a user can select one of the searching processes or achieved by an option menu in a setting for the portable terminal 100.

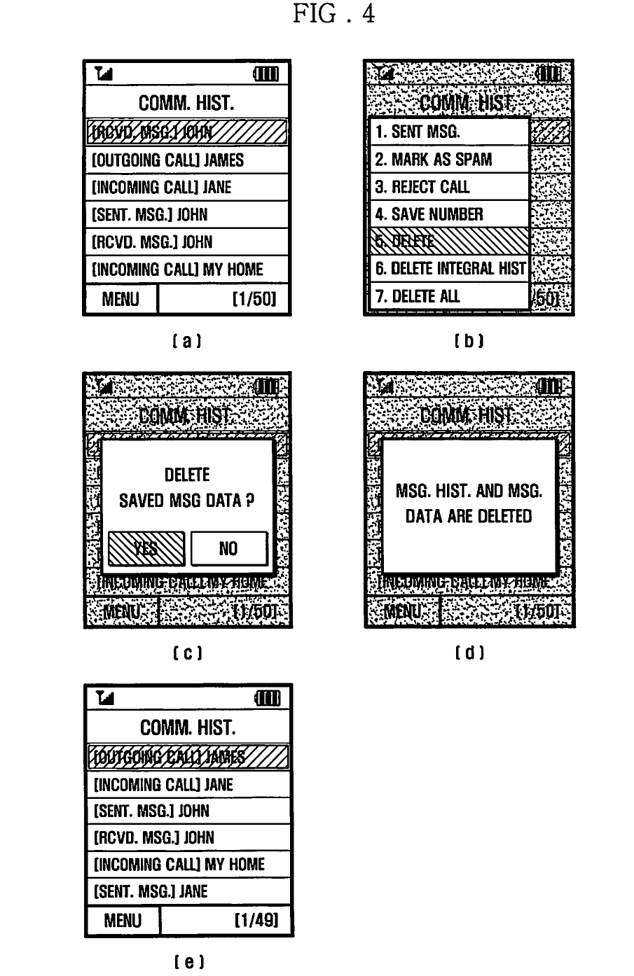

FIG. 4 illustrates screen shots that display a process for deleting a communication history, according to an embodiment of the present invention. As illustrated in screen (a) of FIG. 4, when a call key signal is input, the controller 150 displays a communication history on the display unit 130. The communication history includes received text messages [RCVD. MSG], sent text messages [SENT. MSG.], outgoing calls [OUTGOING CALL], incoming calls [INCOMING CALL], and missed calls [MISSED CALL].

As illustrated in screen (b) of FIG. 4, when “[RCVD. MSG.] John” is selected in screen (a) illustrated in FIG. 4 and a menu key is pressed, the controller 150 displays a pop-up menu on the display unit 130. The pop-up menu may include menus items such as Send message [SEND MSG.], Mark as spam [MARK AS SPAM], Set reject call [REJECT CALL], Save phone number [SAVE NUMBER], Delete [DELETE], Delete integral history DELETE INTEGRAL HIST], and Delete all [DELETE ALL]. A deletion command [DELETE] is selected in the pop-up menu in screen (b) of FIG. 4.

As illustrated in screen (c) of FIG. 4, when a deletion command is selected in the pop-up menu, the controller 150 may display a pop-up window inquiring whether to also delete message data associated with the received text message history.

As illustrated in screen (d) of FIG. 4, when “Yes” is selected in screen (c) of FIG. 4, the controller 150 displays a pop-up window on the display unit 130, which notifies that the received text message history and the message data associated therewith have been deleted.

As illustrated in screen (e) of FIG. 4, the controller 150 displays a communication history, generated after the selected received text message history has been deleted, on the display unit 130. If the numbers at the bottom right of the screen are compared thereto each other, as illustrated in screens (a) and (e) of FIG. 4, 1/50 is changed to 1/49. That is, it can be easily appreciated that the received text message history of “John”, shown in screen (a) of FIG. 4, is deleted from the communication history. In that case, text message data, associated with the received text message history, is also deleted from the data storage area in which message data is stored.

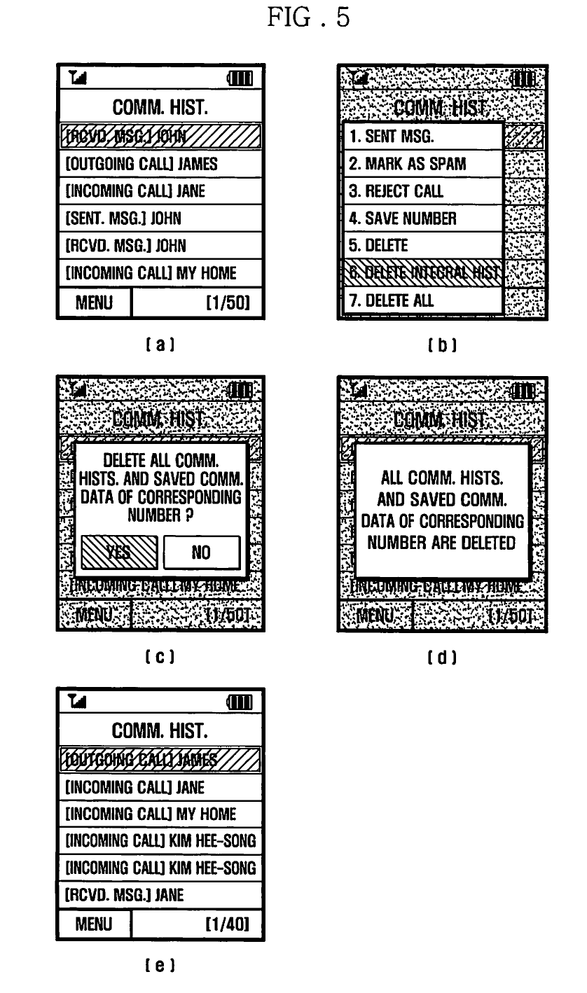

FIG. 5 illustrates screen shots that display a process for deleting an integral history in a communication history, according to an embodiment of the present invention. As illustrated in screen (a) of FIG. 5, when a call key signal is input, the controller 150 displays a communication history on the display unit 130. Like screen (a) of FIG. 4, the communication history includes received text messages [RCVD. MSG], sent text messages [SENT. MSG.], outgoing calls [OUTGOING CALL], incoming calls [INCOMING CALL], and missed calls [MISSED CALL].

As illustrated in screen (b) of FIG. 5, when “[RCVD. MSG.] John” is selected in screen (a) illustrated in FIG. 5 and a menu key is pressed, the controller 150 displays a pop-up menu on the display unit 130. The pop-up menu includes a menus items such as Send message [SEND MSG.], Mark as spam [MARK AS SPAM], Set reject call [REJECT CALL], Save phone number [SAVE NUMBER], Delete [DELETE], Delete integral history DELETE INTEGRAL HIST], and Delete all [DELETE ALL]. The integral history deletion command DELETE INTEGRAL HIST] with respect to “[RCVD. MSG.] John” is selected in the pop-up menu.

As illustrated in screen (c) of FIG. 5, the controller 150 may display a pop-up window inquiring whether to delete a communication history of a corresponding phone number and communication data.

As illustrated in screen (d) of FIG. 5, when “Yes” is selected in screen (c) of FIG. 5, the controller 150 displays a pop-up window on the display unit 130, which notifies that the integral history is deleted after the integral history deletion command has been performed.

As illustrated in screen (e) of FIG. 5, all communication histories with respect to “[RCVD. MSG.] John” selected in the screen illustrated in screen (a) of FIG. 5 are deleted. If the numbers at the bottom right of the screen are compared thereto each other, as illustrated in screens (a) and (e) of FIG. 5, 1/50 is changed to 1/40. That is, three histories with respect to “John” have been deleted from the communication history illustrated in screen (a) of FIG. 5 and seven histories, not presently displayed on the screen, but stored in the memory have also been also deleted therefrom. That is, in this case, the communication data associated with “John” is also deleted from the data storage area in which communication data is stored.

As described above, a communication information deletion method for deleting a communication history and communication data has been described wherein the communication history is a message history. It should, however, be understood that the present invention is not limited by this embodiment. For example, when there is voice message data generated by recording call contents during the call, the communication information deleting method of the present invention can also be adapted to the call history. In addition, when a portable terminal is used that can perform a video call, the method can also be adapted to the video call history and the image data of a video call, which correspond to the stored video call contents. Furthermore, when message data is deleted from a message mailbox, the communication information deletion method can delete a communication history associated with the message data.

As described above, the communication information deletion method of a portable terminal according to the present invention can delete a selected communication history and communication data associated therewith, when the communication histories are deleted, thereby providing users with a convenient mode of operation.

In particular, when communication information about a particular phone number or a particular person name is intended to be deleted, the communication information deletion method can search and delete a communication history and communication data that includes information identical to the communication information to be deleted.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method of deleting communication information in a portable terminal, the method comprising:
selecting a communication history to be deleted;
searching for communication data associated with the selected communication history; and
deleting the communication history and the communication data.

2. The method of claim 1, wherein the communication history includes at least one of a voice call history, a video call history, and a message history.

3. The method of claim 1, wherein the communication data includes one of voice record data of recoding a voice call, message data, or image data of a video call.

4. The method of claim 1, further comprising:
determining whether to delete the communication data.

5. The method of claim 4, wherein determining whether to delete the communication data comprises:
determining if the communication data is protected; and
when the communication data is protected, notifying a user that the communication data is protected and determining if the user still wishes to delete the protected communication data.

6. A method of deleting communication information of a portable terminal, the method comprising:
selecting a history to be deleted from a communication history along with an integral history thereof;
searching the communication history for histories that include information corresponding to that of the selected history;
searching for communication data associated with the selected history; and
deleting any communication history and communication data identified by searching.

7. The method of claim 6, wherein the communication history includes at least one of a call history, a message history, a missed call history, and a call rejection history.

8. The method of claim 6, wherein searching the communication history for the histories including the information corresponding to that of the selected integral history comprises searching at least one of call history, message history, missed call history, and call rejection history.

9. The method of claim 8, wherein the information in each of the call history, the message history, the missed call history, and the call rejection history includes at least one of a phone number and a name that is extracted from the selected integral history to be deleted.

10. The method of claim 6, wherein deleting the any communication history and communication data identified by searching comprises:
determining if the any communication history and communication data is protected; and
when the any communication history and communication data is protected, notifying a user that the any communication history and communication data is protected and determining if the user still wishes to delete the protected any communication history and communication data.

11. The method of claim 6, wherein the communication data includes one of voice call recorded data, message data, or image data of a video call.

12. An apparatus for deleting communication information in a portable terminal, comprising:
a memory for storing a communication history and communication information;
a display unit for displaying the communication history and the communication information; and
a controller for receiving a command to delete a selected history from the displayed communication history, searching for stored communication data associated with the selected communication history, and deleting the selected communication history and the stored associated communication data.

13. The apparatus of claim 12, wherein the communication history comprises at least one of a voice call history, a video call history, and a message history.

14. The apparatus of claim 12, wherein the communication data comprises one of voice record data of recoding a voice call, message data, or image data of a video call.

15. The apparatus of claim 12, wherein the controller determines whether to delete the stored associated communication data.

16. The apparatus of claim 15, wherein the controller determines whether to delete the stored associated communication data by
determining if the stored associated communication data is protected, and
when the stored associated communication data is be protected, controls the display unit to display that the stored associated communication data is protected, and determines if a user still wishes to delete the protected stored associated communication data.

17. The apparatus of claim 12, wherein when an integral history deletion command is received for the selected history from the displayed communication history, the controller searches the stored communication history for history including information corresponding to that of the selected history, searches for stored communication data associated with the selected communication history and associated with the history including information corresponding to that of the selected history, and deletes the selected communication history, the history including the information corresponding to that of the selected history, the stored associated communication data, and the stored communication data associated with the history including information corresponding to that of the selected history.
